(19) United States
(12) Patent Application Publication
(10) Pub. No.: US 2025/0235366 A1
(43) Pub. Date: Jul. 24, 2025

(54) Patient Positioning and Support Apparatus

(71) Applicant: Ebony Flennory, Cocoa, FL (US)

(72) Inventor: Ebony Flennory, Cocoa, FL (US)

(21) Appl. No.: 18/418,237

(22) Filed: Jan. 20, 2024

(51) Int. Cl. A61G 7/10; A61G 7/00

(52) U.S. Cl. CPC A61G 7/1051; A61G 7/001

(57) ABSTRACT

The patient positioning and support apparatus is an innovative medical device designed to aid healthcare workers in safely repositioning patients, thereby reducing the risk of work-related injuries and enhancing patient care. The support apparatus has four fasteners, two of which may be removably affixed to a hospital bed while the caretaker lifts on the other side of the apparatus to help adjust a patient to prevent bed sores.

### CROSS-REFERENCE TO RELATED APPLICATIONS

This application claims benefit to provisional application U.S. 63/567,153 filed on Jan. 20, 2023, and is incorporated in its entirety.

### BACKGROUND OF THE INVENTION

Conventional patient handling devices and methods include slings, hoists, and manual techniques which are either mechanically complex, costly, or prone to causing strain injuries among users. Despite the availability of these devices, there remains a need for an efficient, ergonomic, and straightforward solution that minimizes the risk of injury to healthcare providers while providing comfort and safety to the patient.

This invention pertains to the field of medical assistive devices, specifically to apparatuses designed for repositioning and supporting patients during care. Current methods of patient handling in medical and emergency environments often require significant physical exertion, leading to a high incidence of musculoskeletal injuries among healthcare workers. Such injuries contribute to early retirement, an increase in workers' compensation claims, and a shortage of experienced staff in healthcare settings. The present subject matter is designed to address these issues.

### SUMMARY OF THE INVENTION

The invention, named the “Patient Positioning and Support Apparatus,” introduces a novel device that significantly improves upon the drawbacks of prior art by offering an easy-to-use, ergonomic solution to assist healthcare workers. It allows for the safe turning, changing, and overall handling of patients in a variety of care settings, including hospitals, home care, and emergency response scenarios.

The present subject matter comprises of a sturdy fabric with four latching mechanisms affixed to the four corners of the fabric. The fabric is rectangular in nature so that the patient is able to lie on top of the fabric while in use.

### BRIEF DESCRIPTION OF DRAWINGS

FIG. 1 shows a top view of the patient positioning and support apparatus.

FIG. 2 shows a perspective view of the patient positioning and support apparatus on the side of a hospital bed.

FIG. 3 shows a perspective view of the patient positioning and support apparatus across the top of a hospital bed.

### DETAILED DESCRIPTION OF THE INVENTION

The “Patient Positioning and Support Apparatus” comprises a durable, adaptable framework with strategically placed handles and secure locking mechanisms to provide stability and support during patient handling.

In the following description, like reference numbers are used to identify like elements. Furthermore, the drawings are intended to illustrate major features of exemplary embodiments in a diagrammatic manner. The drawings are not intended to depict every feature of every implementation nor relative dimensions of the depicted elements and are not drawn to scale. least one specification heading is required.

In the following description, numerous specific details are set forth to clearly describe various specific embodiments disclosed herein. One skilled in the art, however, will understand that the presently claimed invention may be practiced without all of the specific details discussed below. In other instances, well known features have not been described so as not to obscure the invention.

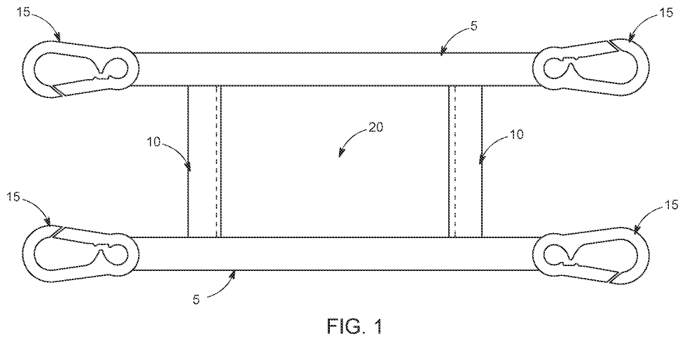

FIG. 1 shows a top view of the patient positioning and support apparatus wherein a sturdy fabric is affixed to two elongated strips of sturdy fabric 5 which are then reinforced with two horizontal strips of fabric 10. The elongated strips of fabric are affixed to four fasteners 15. These four fasteners may be attached to the side of a hospital bed.

The typical use of the present subject matter occurs when the four fasteners are attached to the opposite sides of a hospital bed while the patient lies on the interior fabric 20. The caretaker then unlatches two of the fasteners depending on which direction the caretaker is trying to position the patient.

The caretaker then grabs the two unlatched fasteners and lifts up, causing the patient to slowly roll from his or her original position. The caretaker then relatches the fastener to the side of the hospital bed until it is time to reposition the patient. This repositioning allows for an easy means of preventing bed sores and other issues a bedridden patient typically face.

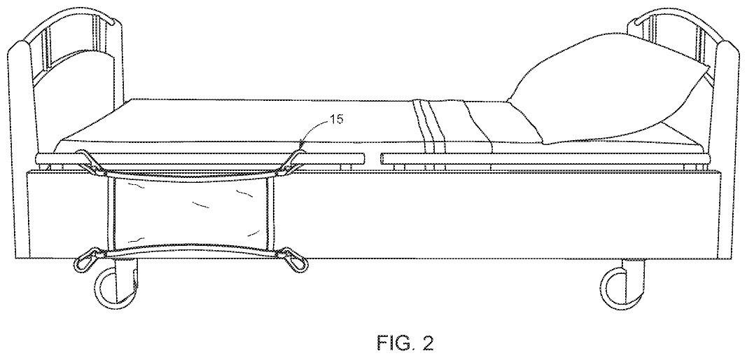

FIG. 2 shows a perspective view of the patient positioning and support apparatus on the side of a hospital bed wherein two of the four fasteners 15 are affixed to the side of the bed.

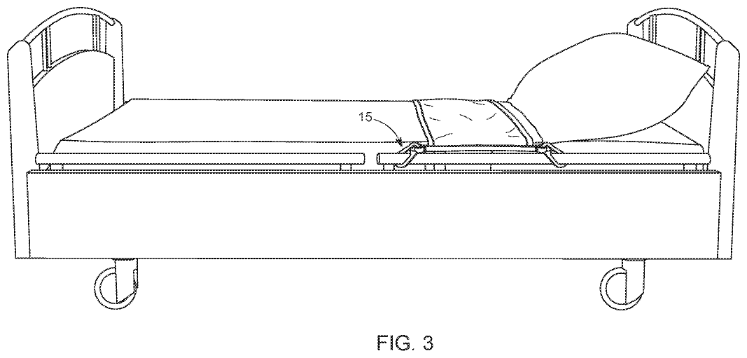

FIG. 3 shows a perspective view of the patient positioning and support apparatus across the top of a hospital bed wherein the four fasteners 15 are affixed to both sides of the bed until it is needed to reposition the patient.

While several illustrative embodiments of the invention have been shown and described, numerous variations and alternative embodiments will occur to those skilled in the art. Such variations and alternative embodiments are contemplated and can be made without departing from the scope of the invention as defined in the appended claims.

1. A patient positioning and support apparatus comprising of four fasteners, two elongated strips of sturdy fabric, two horizontal strips of fabric, and interior fabric.

2. The patient positioning and support apparatus as in claim 1, wherein two elongated strips of sturdy fabric are reinforced and affixed to two horizontal strips of fabric.

3. The patient positioning and support apparatus as in claim 1, wherein the two elongated strips are affixed to the four fasteners.

4. The patient positioning and support apparatus as in claim 1, wherein the interior fabric is affixed to the two elongated strips and two horizontal strips of fabric.

5. The patient positioning and support apparatus as in claim 1, wherein the four fasteners affix to the sides of a hospital bed.

6. The patient positioning and support apparatus as in claim 1, wherein a caretaker unlatches and lifts on two of the fasteners to reposition a patient.
